(19) United States
(12) Patent Application Publication
(10) Pub. No.: US 2024/0286244 A1
(43) Pub. Date: Aug. 29, 2024

(54) ELECTROSTATIC SUCTION CUP DEVICE FOR WAFER CHEMICAL MECHANICAL POLISHING

(71) Applicant: SHOXPROOF TECHNOLOGY CO., LTD., TAINAN CITY (TW)

(72) Inventor: YAO-SUNG WEI, TAINAN CITY (TW)

(21) Appl. No.: 18/538,398

(22) Filed: Dec. 13, 2023

(30) Foreign Application Priority Data
Feb. 24, 2023 (TW) 112201676

(51) Int. Cl. B24B 37/27; H02N 13/00

(52) U.S. Cl. CPC B24B 37/27; H02N 13/00

(57) ABSTRACT

The invention relates to an electrostatic suction cup device for wafer chemical mechanical polishing, which mainly includes a wafer carrier having a suction surface from an upper end thereof; an electrostatic suction cup arranged at the corresponding suction surface in the wafer carrier; and a control module connected to the electrostatic suction cup so that the electrostatic suction cup can be controlled by the control module to generate static electricity to adsorb the wafer to the suction surface for chemical-mechanical polishing operations. Hence, wafers can be steadily absorbed without being affected by wafer thickness to improve yield and process improvement, can remove the time and cost of gluing and film application process corresponding to strengthening the wafer strength before the wafer process, can avoid the procedure, cost and risk of debonding and film removal after the process, and can increase the practical efficacy characteristics in its overall implementation.

### BACKGROUND OF THE PRESENT INVENTION

### Field of Invention

The present invention relates to an electrostatic suction cup device for wafer chemical mechanical polishing, in particular to a device that can stably absorb wafers regardless of their thickness, in order to improve the yield and process, achieve a better thinning effect, and remove the need for the pre-process of applying adhesive and film to enhance wafer strength, as well as the post-process of removing adhesive and film, reducing the associated time, cost, and risk of wafer fragmentation. Furthermore, it saves the time and cost of frequent maintenance required by the conventional vacuum suction method, and the innovative design of the electrostatic suction cup device for wafer chemical mechanical polishing has enhanced its practical effectiveness and characteristics in its overall implementation and use.

### Description of Related Arts

In recent years, the semiconductor industry has developed rapidly, and the application of various semiconductor chips is extensive. The research, development, and production of semiconductor chips often affect many industries globally. Wafer is the abbreviation for semiconductor crystal round wafer, which is a thin slice of a cylindrical semiconductor crystal that is used as a carrier substrate in the integrated circuit manufacturing process and in the manufacture of solar cells. Because of its circular shape, it is called a wafer. The most common ones are silicon wafers, but there are also gallium nitride wafers, silicon carbide wafers, etc.

In each process of the wafer, if there are defects such as uneven surface smoothness and unevenness, it will affect the yield and efficiency of the final product, so chemical etching and mechanical processing will be used in the microcircuit formed by repeated exposure, development and etching. Chemical-Mechanical Polishing (CMP) is a process in which a slurry is used to thin or polish the wafer, reducing or removing the height differences caused by repeated stacking processes and reducing the thickness of the wafer substrate or film material in the process. In addition to controlling the thickness of the wafer in the Chemical-Mechanical Polishing (CMP) process, the final surface polishing of the wafer is also a Chemical-Mechanical Polishing (CMP) procedure, removing the residue on the wafer surface after reaching the target thickness (mirror finishing) to prepare for the next semiconductor process.

In the Chemical-Mechanical Polishing (CMP) process of wafers, the suction cup of the wafer carrier is mainly used to suck up the wafer and transfer it to the corresponding polishing pad, and at the same time rotate the suction cup of the wafer carrier and polishing pad to polish the wafer. However, the suction cup is generally a vacuum suction cup, and although the vacuum suction cup can achieve the expected effect of sucking the wafer, in the process of its actual operation, it is also found that due to the progress of science and technology and the rapid change of technology, the diameter of the wafer is getting larger and the thickness is getting thinner. As a result, when the vacuum suction cup suctions a wafer with a large diameter and a thin thickness, due to insufficient stress on the wafer, the wafer is easily damaged by the suction force of the vacuum suction cup. Although, the industry will coat an adhesive layer on the surface of the wafer to use the adhesive layer to increase the stress of the wafer, during the process of removing the adhesive layer from the wafer after polishing, it is also easy to cause damage to the wafer, resulting in a limit on the thickness of the wafer that the vacuum suction cup can pick up.

In addition, some companies have developed the use of a ceramic suction cup to suck the wafer and transfer it to the polishing pad for polishing operations, but the ceramic suction cup allows the vacuum suction force to suck the wafer through the micropores on the surface of the ceramic suction cup, and the fine particles contained in the slurry used in the polishing process of the wafer are easy to block the micropores on the surface of the ceramic suction cup, resulting in the need to clean the ceramic suction cup from time to time in order to maintain sufficient suction power of the ceramic suction cup, making the ceramic suction cup extremely inconvenient in the overall operation and use.

Therefore, the inventor, based on years of rich design and development experience in the industry, has studied and improved the conventional technical means and provided an electrostatic suction cup device for wafer chemical mechanical polishing, aiming to achieve better practical value.

### SUMMARY OF THE PRESENT INVENTION

The main object of the present invention is to provide an electrostatic suction cup device for wafer chemical mechanical polishing, which mainly uses an electrostatic suction cup to absorb wafer for Chemical-Mechanical Polishing (CMP) operations, so that wafer can be steadily absorbed without being affected by wafer thickness, so as to improve yield and process improvement, achieve a better thinning effect, and remove the time and cost of gluing and film application corresponding to strengthening the strength of wafers before the wafer process. It can also avoid the procedures, costs and risk of fragmentation of degumming and film removal after the process, saving the time and cost of frequent maintenance required by the current vacuum suction method and adding practical and functional features to its overall implementation.

The main purpose and effect of the electrostatic suction cup device for wafer chemical mechanical polishing of the present invention are achieved by the following specific technical means,
which mainly include a wafer carrier and an electrostatic suction cup, wherein
the wafer carrier has a suction surface formed at an upper end thereof, wherein
the electrostatic suction cup is arranged in the wafer carrier at a position corresponding to the suction surface, and the electrostatic suction cup has a control module connected thereof, so that the control module is capable of being used to control the electrostatic suction cup to generate static electricity to adsorb the wafer on the suction surface for chemical mechanical polishing [Chemical-Mechanical Polishing, CMP] operation.

According to a preferred embodiment of the electrostatic suction cup device for wafer chemical mechanical polishing of the present invention, the wafer carrier has a quick-release unit provided at a bottom thereof for combination with a machine.

### BRIEF DESCRIPTION OF THE DRAWINGS

FIG. 1 is a perspective view of a structure according to the present invention.

FIG. 2 is a view of the use state according to the present invention.

FIG. 3 is a view of the use state of the quick-release unit according to the present invention.

### DETAILED DESCRIPTION OF THE PREFERRED EMBODIMENT

In order to have a more complete and clear disclosure of the technical content used in the present invention, the purpose of the invention, and the effect achieved, the present invention is described in detail below, referring to the disclosed drawings and drawing numbers.

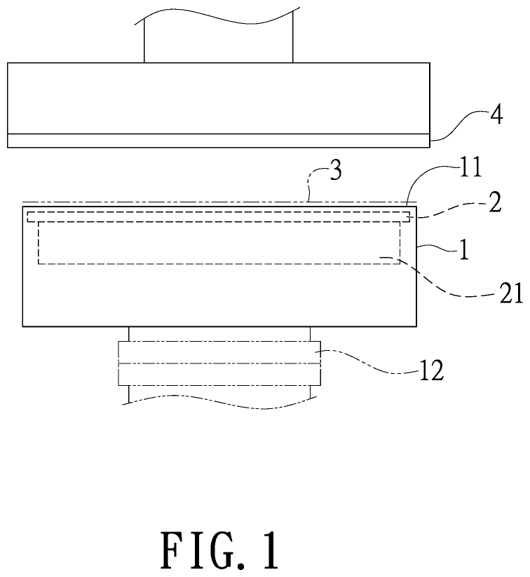

First, referring to FIG. 1, which is a structural perspective view of the present invention, an electrostatic suction cup device for wafer chemical mechanical polishing according to the present invention includes a wafer carrier (1) and an electrostatic suction cup (2), wherein
the wafer carrier (1) has a suction surface (11) formed at an upper end thereof, and a quick-release unit (12) provided at a bottom of the wafer carrier (1) for combination with a machine;
the electrostatic suction cup (2) is arranged at the corresponding suction surface (11) in the wafer carrier (1), and a control module (21) is connected to the electrostatic suction cup (2), so that the control module (21) is capable of being used to control the electrostatic suction cup (2) to generate static electricity.

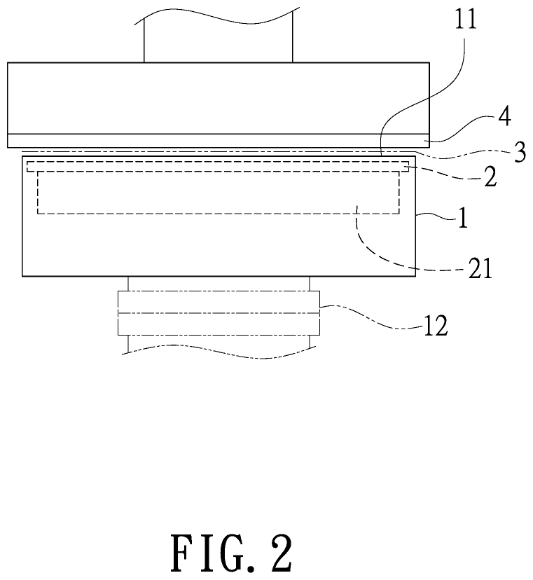

In this way, during operation and use of the present invention, the control module (21) can control the electrostatic suction cup (2) to generate static electricity so that the wafer (3) is attracted by the electrostatic attraction of the electrostatic suction cup (2) and adsorbed on the suction surface (11) of the wafer carrier (1). Then, the wafer carrier (1) is moved to the corresponding polishing pad (4) through the machine, referring to FIG. 2 for a view of the use state of the present invention, the polishing pad (4) can come into contact with the wafer (3) adsorbed on the suction surface (11) of the wafer carrier (1) and simultaneously rotate the wafer carrier (1) and the polishing pad (4) to perform Chemical-Mechanical Polishing (CMP) on the wafer (3).

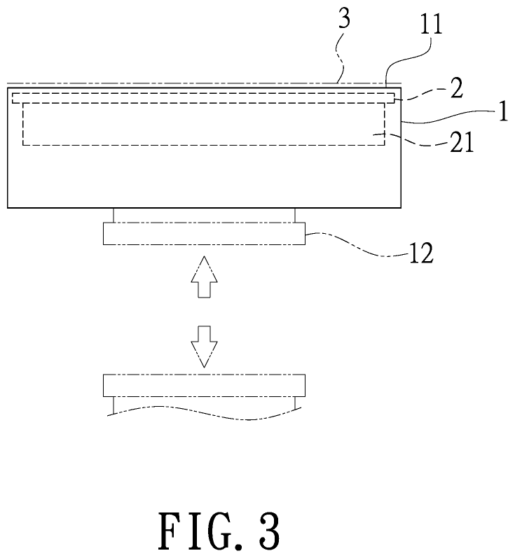

In addition, referring to the view of the use state of the quick-release unit of the present invention in FIG. 3, because the bottom of the wafer carrier (1) is combined with the machine through the quick-release unit (12), the wafer (3) is adsorbed on the suction surface (11) of this wafer carrier (1) by the electrostatic suction cup (2), and after the polishing is completed, the quick-release unit (12) can be directly used to detach the wafer carrier (1) from the combined state with the machine, that is, the wafer (3) can be conveniently maintained by the electrostatic suction cup (2) adsorbed on the suction surface (11) of the wafer carrier (1) and moved to the next process, without the wafer (3) being separated from the suction surface (11) of the wafer carrier (1), so as to reduce the damage probability of the wafer (3).

From the above, the description of the use and embodiment of the present invention shows that compared with the prior art means, advantages and effects provided by the present invention include the following:
1. It can increase the yield and improve the manufacturing process.
2. Achieve better thinning effect.
3. Excluding the time and cost of the gluing and coating program required to enhance the strength of the wafer before the wafer fabrication process.
4. Avoid the procedures, costs and risk of fragmentation of the glue and film removal after the manufacturing process.
5. Save the time and cost of frequent maintenance required by conventional vacuum suction methods.

Additional changes and modifications will readily occur to those skilled in the art. Therefore, the invention in its broader aspects is not limited to the specific details, aforementioned embodiments or views shown and described herein. Accordingly, various modifications may be made without departing from the spirit or scope of the general inventive concept as defined by the appended claims and their equivalent.

What is claimed is:

1. An electrostatic suction cup device for wafer chemical mechanical polishing, comprising a wafer carrier and an electrostatic suction cup, wherein
the wafer carrier has a suction surface formed at an upper end thereof, wherein
the electrostatic suction cup is arranged in the wafer carrier at a position corresponding to the suction surface, and the electrostatic suction cup has a control module connected thereof, so that the control module is capable of being used to control the electrostatic suction cup to generate static electricity to adsorb the wafer on the suction surface for chemical mechanical polishing (CMP) operation.

2. The electrostatic suction cup device for wafer chemical mechanical polishing as claimed in claim 1, wherein the wafer carrier has a quick-release unit provided at a bottom thereof for combination with a machine.
